(19) United States
(12) Patent Application Publication
(10) Pub. No.: US 2008/0040658 A1
(43) Pub. Date: Feb. 14, 2008

(54) Linking of Content Portions Developed Independently

(75) Inventors: Venkateswara K. Reddy, Bangalore (IN); Graeme Laycock, Hunters Hill (AU); Michael E. Sturgeon, Peoria, AZ (US)

Correspondence Address: HONEYWELL INTERNATIONAL INC., 101 COLUMBIA ROAD, P O BOX 2245, MORRISTOWN, NJ, 07962-2245, US

(73) Assignee: HONEYWELL INTERNATIONAL INC., Morristown, NJ (US)

(21) Appl. No.: 11/309,179

(22) Filed: Jul. 7, 2006

(51) Int. Cl. G06F 15/00

(52) U.S. Cl. 715/234

(57) ABSTRACT

Linking of content portions developed independently. A publishing system receives a document containing link identifiers identifying corresponding referenced content portions and forms a set of display files. The publishing system generates link information indicating the display file containing the content portion corresponding to each link identifier. A developer encodes the link identifiers in the referencing content portions, and the publishing system may provide a mechanism to link the referencing content portions to the referenced content portions using the link identifiers. Thus, in an example scenario, when a user clicks on the referencing content portion, the link identifier is sent to a server system, which uses the link information provided by the publishing system to identify the display file containing the referenced content portion.

### BACKGROUND OF THE INVENTION

1. Field of the Invention

The present invention generally relates to content publishing systems, and more specifically to a method and apparatus for linking of content portions developed independently.

2. Related Art

There is often a need to link content portions developed independently. For example, in documents such as manuals covering a complex system, there are often references from one portion (content portion) to another portion of the same or different manual, typically for more detailed/relevant information or explanation. To facilitate easy navigation, links (e.g., hyperlink in case of HTML encoding) are provided from the referring content portion to the referenced content portion.

There has been a recognized challenge in ensuring accurate linking of content portions, particularly when developing a large content. The challenges are compounded in situations where diverse groups of people develop different portions, potentially in different geographical locations.

According to one prior approach, the links are incorporated manually after all the content portions are developed. In such an approach, the performer of integration has a view of the content as a whole and incorporates the links appropriately. One drawback with such an approach is that the time to provide the integrated content is high due to the sequencing of the integration after the development of the content portions and the manual effort required. In addition, maintenance (changes, additions, deletions, etc.) of the links and the content portions may require substantial effort.

Another prior approach overcomes some of such drawbacks by requiring identification of specific files, which would contain the content portions developed or to be developed by each developer, and making the list of files available to all the developers. Each developer would then link a referring portion to the specific file containing the desired referenced portion.

One disadvantage with such an approach is that any later change made to the name of one of the files may necessitate manually changing the links associated with the referring content portions. In another scenario, each file developed by a developer may be further split into smaller files by a software system typically to reduce network bandwidth or for convenience in display. The prior approach may not be suitable since the name of the smaller files containing the referenced portion may not be known beforehand.

What is therefore needed is an approach, which enables linking of content portions developed independently while addressing one or more problems/requirements described above.

### BRIEF DESCRIPTION OF THE DRAWINGS

The present invention will be described with reference to the accompanying drawings briefly described below.

FIG. 1 is a block diagram illustrating an example environment in which various aspects of the present invention can be implemented.

FIG. 2 is a flowchart illustrating the manner in which a publishing system facilitates linking of content portions developed independently according to an aspect of the present invention.

FIG. 3 is a block diagram illustrating the details of a publishing system in one embodiment.

FIG. 4 depicts the contents of a document containing link identifiers identifying corresponding (referenced) content portions according to an example convention.

FIG. 5 depicts the contents of a display file formed from the contents of a document containing referenced content portions.

FIG. 6 depicts the index information generated from a set of display files formed from contents of a document containing referenced content portions.

FIG. 7 depicts the link information generated from the contents of a document containing referenced content portions.

FIG. 8 depicts the content of a document containing link identifiers linking referring content portions to referenced content portions in other documents.

FIGS. 9A and 9B together depict the content of a display file formed from the content of a document containing referring content portions.

FIG. 10 is a flowchart illustrating the manner in which display files are linked according to an aspect of the present invention.

FIG. 11 is a block diagram illustrating the details of a digital processing system in which various aspects of the present invention are operative by execution of appropriate software instructions.

In the drawings, like reference numbers generally indicate identical, functionally similar, and/or structurally similar elements. The drawing in which an element first appears is indicated by the leftmost digit(s) in the corresponding reference number.

### DETAILED DESCRIPTION OF THE PREFERRED EMBODIMENTS

1. Overview

According to an aspect of the present invention, a publishing system receives a document containing link identifiers identifying corresponding referenced content portions and forms a set of display files. The publishing system generates link information indicating the display file containing the content portion corresponding to each link identifier. A developer encodes the link identifiers in the referencing content portions, and the publishing system may provide a mechanism to link the referencing content portions to the referenced content portions using the link identifiers. Thus, in an example scenario, when a user clicks on the referencing content portion, the link identifier is sent to a server system, which uses the link information provided by the publishing system to identify the display file containing the referenced content portion.

According to another aspect of the present invention, the publishing system generates index information indicating a unique identifier of the document, the directory location of the set of display files formed from the document and the identifier of the display file for each of the headings/sections in the document. The publishing system also generates link information to include for each link identifier the unique identifier of the document and the heading/section in the document that is at the start of the referenced content portion. In a scenario where two link identifiers contained in different documents are identical, the unique identifier of the document along with the link identifier may be used to identify the referenced content portions.

Several aspects of the invention are described below with reference to examples for illustration. It should be understood that numerous specific details, relationships, and methods are set forth to provide a full understanding of the invention. One skilled in the relevant art, however, will readily recognize that the invention can be practiced without one or more of the specific details, or with other methods, etc. In other instances, well-known structures or operations are not shown in detail to avoid obscuring the features of the invention.

2. Example Environment

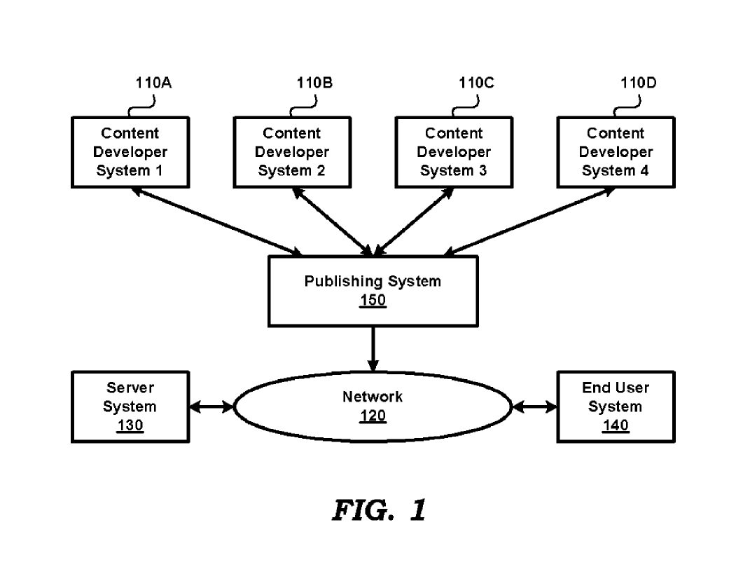

FIG. 1 is a block diagram illustrating an example environment in which various aspects of the present invention can be implemented. The environment is shown containing content developer systems 111A to 110D, network 120, server system 130, end user system 140 and publishing system 150. Each system is described in further detail below.

Content developer systems 110A to 110D enable content developers to generate content portions independently using appropriate tools and to send the content portions to publishing system 150. The content may be encoded according to various aspects of the present invention to facilitate desired linking of content portions, as described in sections below. In general, multiple content portions can be included in a single file and provided as an input to publishing system 150.

Network 120 provides necessary communication between publishing system 150, server system 130 and end user system 140 using protocols such as TCP/IP well known in the relevant arts. Server system 130 receives requests on network 120 to access various content portions from end user system 140 and sends a response containing the requested content portions. Various aspects of the present invention enable the content portions to be accurately identified and sent in the responses, as described in sections below.

Publishing system 150 receives content portions encoded according to various aspects of the present invention from content developer systems 110A to 110D and publishes/converts the content portions to a format suitable for display to end users by the combination of server system 130 and end user system 140. It may be appreciated that the conversion of the content portions may also be determined by factors (other than display) such as bandwidth of the network or restrictions on the server system. The operation of publishing system 150 is described below in further detail with various examples.

3. Linking of Content Portions Developed Independently

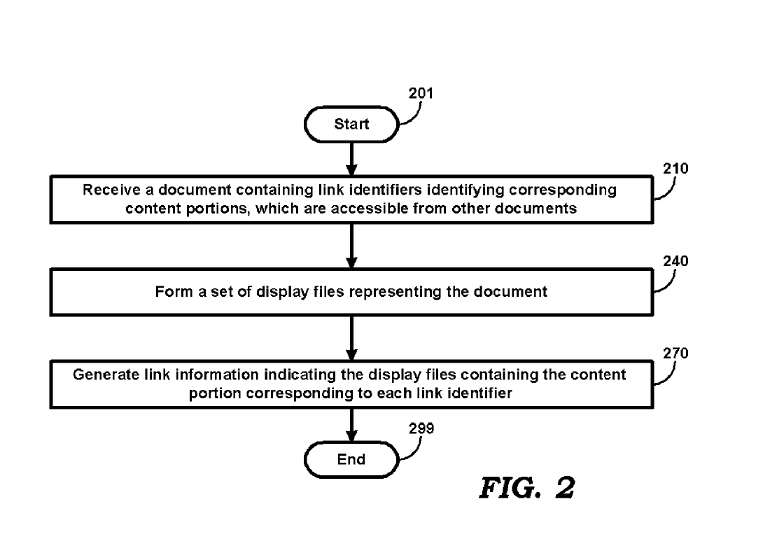

FIG. 2 is a flowchart illustrating the manner in which content portions developed independently are linked according to an aspect of the present invention. The flowchart is described with respect to FIG. 1 merely for illustration. The features can however be implemented in other environments as well, as will be apparent to one skilled in the relevant arts by reading the disclosure provided herein. The flowchart begins in step 201, wherein control immediately passes to step 210.

In step 210, publishing system 150 receives a document (or file) containing link identifiers identifying corresponding content portions, which are accessible from other documents. The document is received from one of content developer systems 110A to 110D. In an embodiment described below, the link identifiers are specified as tags in the document containing text identifying a corresponding portion of text beginning from the tag to the end of the document. However, the link identifiers and the corresponding content portion can be specified according to any suitable convention consistent with the implementation of other systems.

In step 240, publishing system 150 forms a set of display files representing the document received in step 210. In an embodiment, the display files are in a format that is required by end user system 140 and are to be stored in server system 130. The display files are encoded in hypertext markup language (HTML) and are stored in a file server in server system 130. A web browser in end user system 140 enables a user to browse the content of the HTML files by sending URLs (containing the link identifiers) to server system 130.

In step 270, publishing system 150 generates link information indicating the display files containing the content portion corresponding to each link identifier. In an embodiment described below, the link information is generated in extended markup language (XML). However, the link information can be generated according to any convention. The link information is used later to determine the specific display file containing the desired referenced content portion, as described with examples below. The flowchart ends in step 299.

Thus, publishing system 150 facilitates linking of content portions developed independently using the link information noted above. The features of above can be implemented in various embodiments. The description is continued with respect to an example embodiment.

4. Publishing System

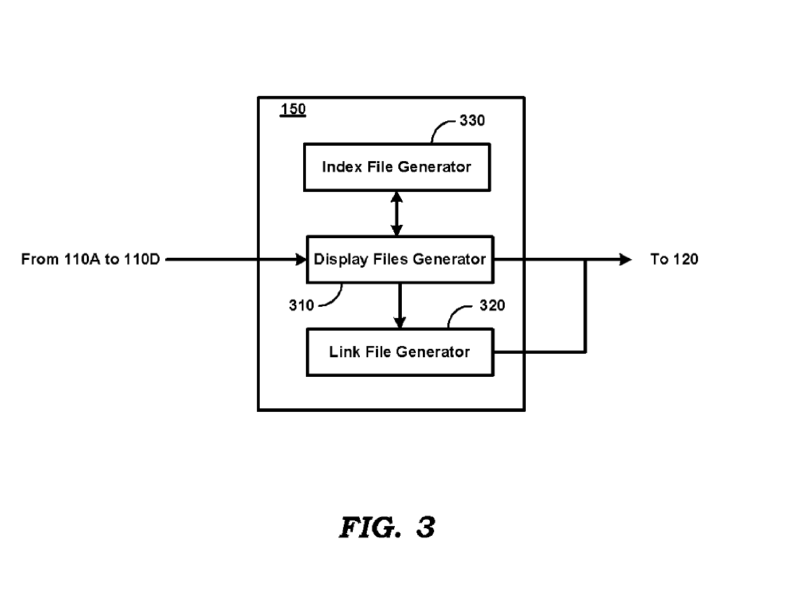

FIG. 3 is a block diagram illustrating the details of a publishing system 150 in one embodiment. The block diagram is shown containing display files generator 310, link file generator 320 and index file generator 330. Each block is described below in further detail below.

Display files generator 310 receives documents containing link identifiers identifying corresponding content portions from any of content developer systems 110A to 110D and forms a set of display files representing each received document. In an embodiment, each content portion is contained entirely in a display file (though alternative embodiments can contain the content portion in multiple display files), and the specific content portions to be included in each display file can be controlled by user specified formats in a known way. In the embodiment described below, “HTML Transit” from Avantstar Corporation (Avantstar, Inc., 18986 Lake Drive East, Chanhassen, Minn. 55317 USA, phone: +1.952.351.8500) is used to convert received documents into HTML files and to publish them on a file server. The set of display files is sent for storing in (or otherwise make accessible to) server system 130 using network 120.

Display files generator 310 also parses the received document to locate the link identifiers, and sends the located link identifiers and the display files corresponding to each link identifier to link file generator 320.

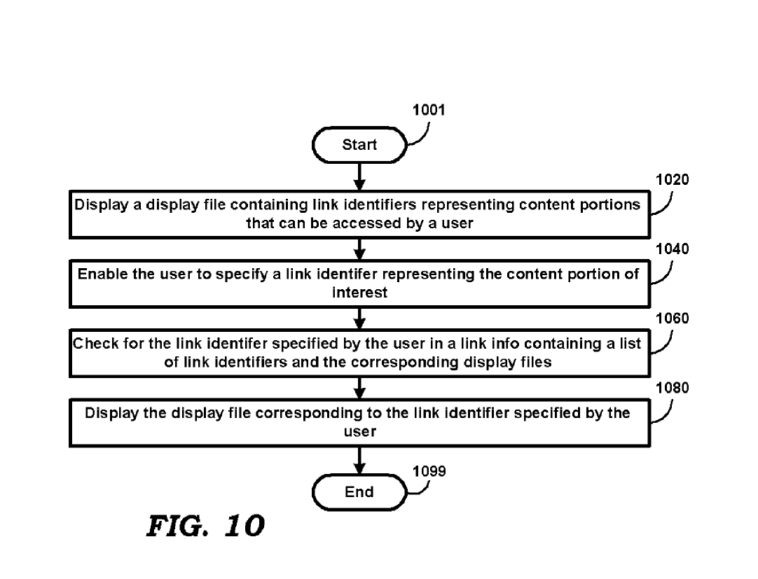

Display files generator 310 also receives documents containing referring content portions that link to desired referenced portions using link identifiers, which identify the corresponding referenced content portions. Display files generator 310 forms a set of display files representing each received document and may provide a mechanism to link to the display files containing the referenced content portions. An example embodiment in which display files containing referring content portions link to other display files containing referenced content portions is described in detail with reference to FIG. 10.

Link file generator 320 receives link identifiers and the display files containing the content portion corresponding to each link identifier for each received document from display files generator 310 and generates link information. The link information indicates the display file containing the content portion corresponding to each link identifier. The link information for all the received documents is sent for storing in (or otherwise made accessible to) server system 130 via network 120.

It is often noted that link identifiers may be duplicated for referenced content portions in different documents and it may be preferable to uniquely identify each content portion. In such a scenario, a unique identifier may be generated for each of the received documents and may be used along with the link identifier to uniquely identify the referenced content portions. The additional associated processing is described below.

Display files generator 310 sends the received documents and the set of display files representing each received document to index file generator 330, and forwards to link file generator 320, the index information received from index file generator 330. The index information may be sent for storing in (or otherwise made accessible to) server system 130 using network 120.

Index file generator 330 receives each document and the set of display files representing each received document from display files generator 310 and generates index information. The index information indicates for each of the received documents—a unique identifier of the document, the directory location of the set of display files formed from the document and the identifier of the display file for each of the headings/sections in the document. In an embodiment described below, the index information is generated in extended markup language (XML). Link file generator 320 on receiving index information from display files generator 310 may generate the link information to include for each link identifier the unique identifier of the document containing the referenced content portion and the heading/section in the document that is at the start of the referenced content portion.

It may be appreciated that the publishing system enables content developers to link content portions developed independently. The manner in which the linking of content portions is enabled is illustrated below with an example.

5. Illustration

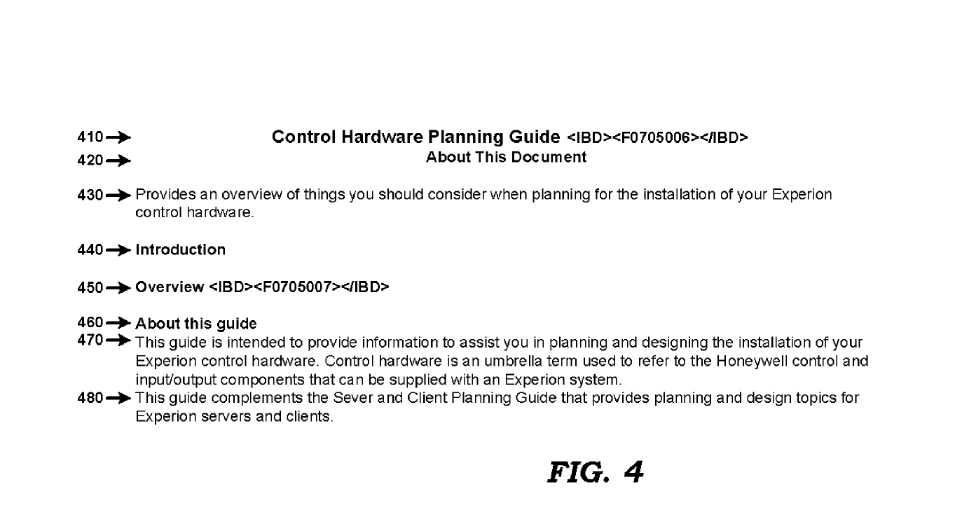

FIGS. 4, 5, 6, 7, 8, 9A and 9B together are used to illustrate the manner in which the approach(es) of FIG. 2 can be used to link content portions developed independently. Each Figure is described below in further detail

FIG. 4 depicts the contents of a document containing link identifiers identifying corresponding content portions (that is, referenced content portions).

Line 410 specifies a link identifier “F0705006” using tag “<IBD>” and the corresponding end tag “</IBD>”. The link identifier “F0705006” identifies content portion from the end tag to the end of the document that is as specified in lines 410 to 480. Similarly, line 450 specifies link identifier “F0705007” identifying the content portion specified in lines 450 to 480.

Thus, a developer would include the link identifiers of lines 410 and 450 to refer to content portions specified in lines 410-480, and 450-480 respectively. It should be observed that a content portion is deemed to extend to the end of the document in the convention used in FIG. 4. However, alternative approaches can be used which precisely indicate the end of a content portion at any desired position in the document.

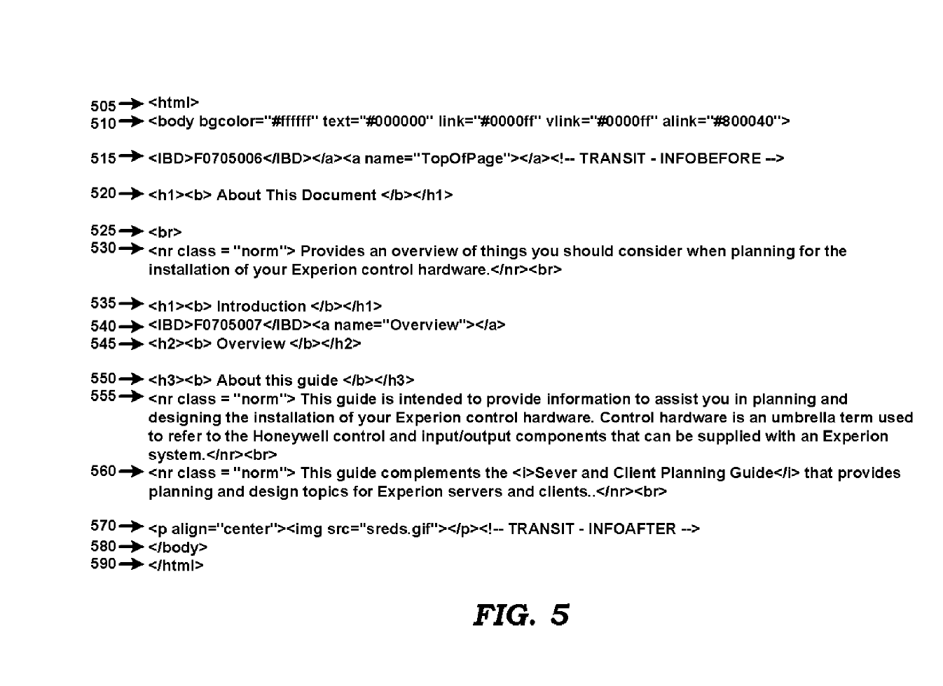

Similarly, it is assumed that the document of FIG. 4 has been generated using Word Processing software (e.g., Microsoft[R] Word software available from Microsoft Corporation) in one of the content developer system 110A-110D. The document is received and processed by publishing system 150 to generate the display file of FIG. 5.

FIG. 5 depicts the contents of a display file (encoded as HTML, described in further detail in a document entitled “HTML & XHTML: The Definitive Guide, Fifth Edition” by Chuck Musciano and Bill Kennedy, published by O'Reilly with ISBN 0-596-00382-X) formed from the contents of a document containing referenced content portions (depicted in FIG. 4). Lines 505 to 590 specify html tags that are formed corresponding to lines 410 to 480.

Line 515 specifies tag “<IBD> . . . </IBD>” that are formed corresponding to line 410, containing the link identifier “F0705006”. Line 515 also specifies the heading/section name “TopOfPage” that corresponds to the start of the referenced portion for the link identifier “F0705006”. The heading/section “TopOfPage” is a special heading given to the beginning of the document and may not be specified in the document as such. Similarly, line 540 corresponds to html tags formed for line 450 and specifies a heading/section name “Overview”.

It may be appreciated that in a scenario where a heading/section corresponds to the start of the referenced content portion identified by a link identifier (as shown in line 515), the heading/section name may be used instead of the link identifier during the generation of the link information. The heading/section name provides a more user friendly (descriptive) alternative to link identifies. It may be noted, that in the above example, each of the link identifiers have a corresponding heading/section name. However, the link identifiers may be used to specify referenced content portions that may contain a part or a multiple of headings/sections of the document.

It may also be appreciated that FIG. 5 depicts only one display file that has been generated from the document depicted in FIG. 4. In a typical scenario, multiple display files may be formed while processing the content of a document. The display files formed may be determined by user-defined formats or may be dynamically formed using pre-defined formats/templates. Display files generator 310 sends the set of display files formed from the contents of a document to index file generator 330. The index information generated by index file generator 330 is described below.

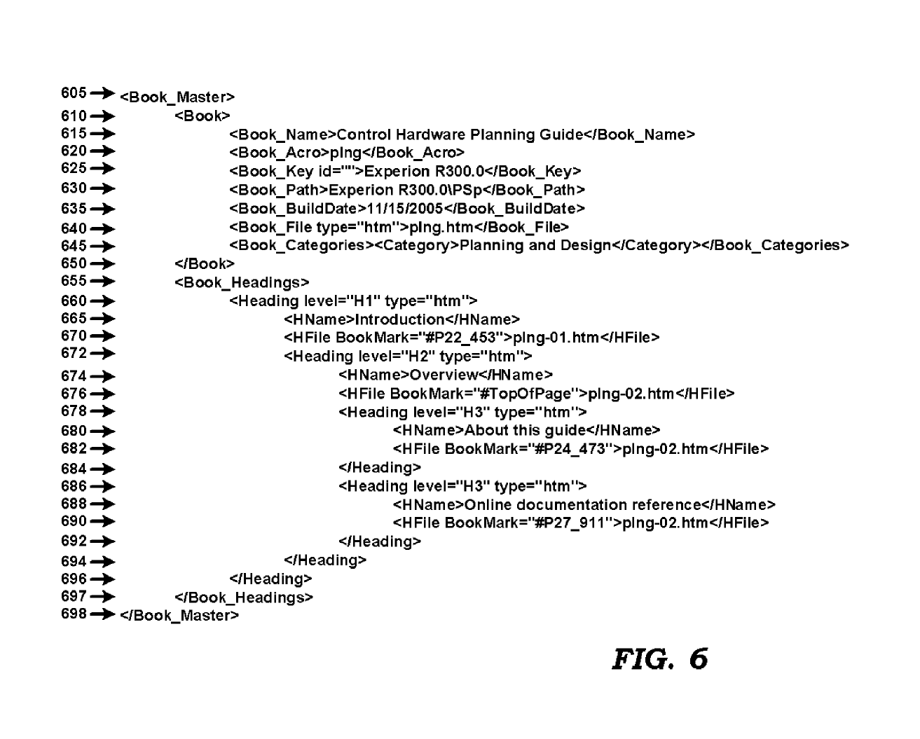

FIG. 6 depicts the index information (encoded as XML, described in further detail in a document entitled “XML in a Nutshell, Third Edition” by Elliotte Rusty Harold and W. Scott Means, published by O'Reilly with ISBN 0-596-00764-7) generated from a set of display files (depicted in FIG. 5) formed from contents of a document containing referenced content portions (depicted in FIG. 4).

Lines 605 to 698 specify the index of multiple documents (or “books”). Lines 610 to 650 (content of tag “<Book> . . . </Book>”) specify information about a single document and lines 655 to 697 (content of tag “<Book_Headings> . . . </Book_Headings>”) specify the table of contents for each of the documents indicating the display file corresponding to each heading/section (which information would be available from encoding used by Microsoft® Word software, assuming the document of FIG. 4 is developed using Microsoft® Word software) in the document.

Line 615 (“<Book_Name> . . . </Book_Name>”) specifies the name of the document and line 620 (“<Book_Acro> . . . </Book_Acro>”) specifies a unique identifier “plng” (generated by publishing system 150) for the document. In the scenario where two link identifiers contained in two different documents are the same, then the identifier of the document along with the link identifier can be used to uniquely identify the content portion. Line 630 (“<Book_Path> . . . </Book_Path>”) specifies the directory location “Experion R300.0\PSp” of the display files formed representing the document in the file system. Line 640 (“Book_File> . . . </Book_File>”) specifies the identifier/name “plng.htm” of the display file corresponding to the beginning of the document and contains the heading/section “TopOfPage”.

Lines 660, 672, 678, 686 (content of tag “<Heading> . . . </Heading>”) specify the details of various headings/sections in the document. Lines 678 to 684 specify a single heading/section in the document with name “About this guide” as specified in line 680 (“<HName> . . . </HName>”) and the identifier/name of the display file “plng-02.htm” containing the heading/section as specified in line 682 (““<HFile> . . . </HFile>”). Similarly the headings/sections of lines 660, 672 and 686 specify names “Introduction”, “Overview”, “Online documentation reference” and their corresponding display file identifiers/names “plng-01.htm” and “plng-02.htm”.

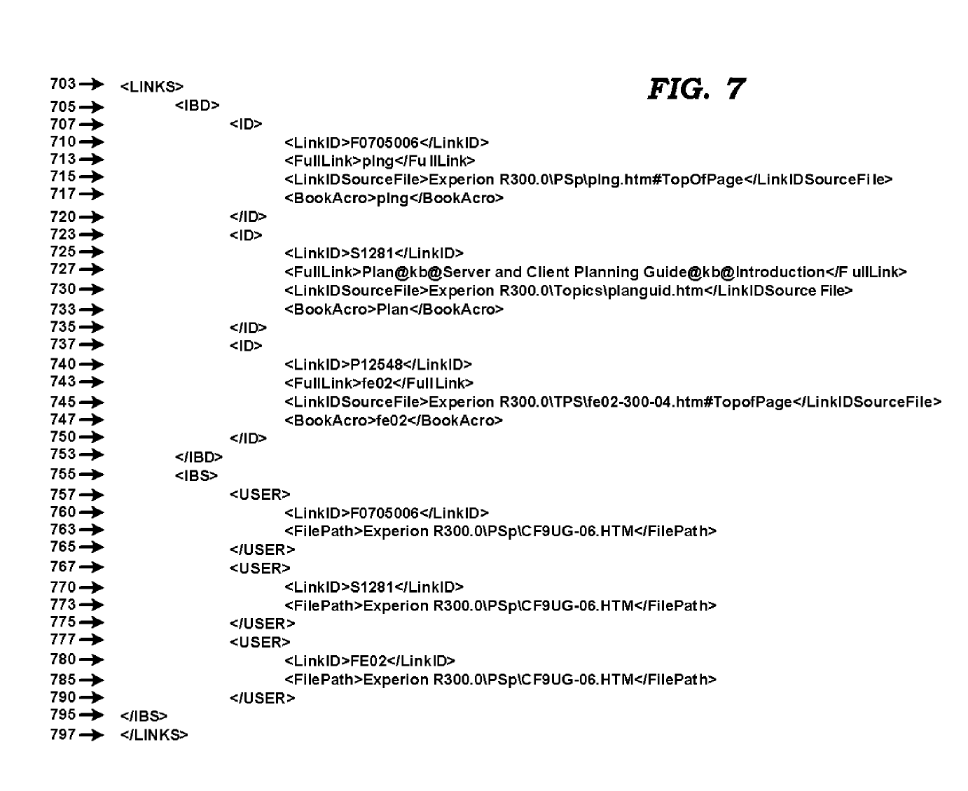

It may be appreciated that the format of lines 610 to 650 may be replicated for multiple documents and the format of lines 678 to 684 may be replicated for multiple headings/sections in each of the documents. The index information depicted in FIG. 6 is generated by index file generator 330 and is forwarded to link file generator 320 via display files generator 310. Display files generator 310 also sends along with the index information, the link identifiers contained in the document (depicted in FIG. 4) and the set of display files formed from the document (depicted in FIG. 5) to link file generator 320. The link information generated by link file generator 320 is described below in detail. FIG. 7 depicts the link information (encoded in XML) generated from the contents of a document containing referenced content portions (depicted in FIG. 4).

Broadly, lines 703 to 797 (content of tag “<LINKS> . . . </LINKS>”) specify the link identifiers contained in all the documents (containing referencing and referenced content portions) processed by publishing system 150. Lines 705 to 753 (content of tag “<IBD> . . . </IBD>”) specify the link identifiers identifying corresponding referenced content portions in different documents. Lines 755 to 795 (content of tag “<IBS> . . . </IBS>”) specify the display files and the link identifiers that are referenced from the content of the corresponding display file. The lines are described in further detail below.

Lines 707 to 720 (“<ID> . . . </ID>”) specify the details of a single link identifier “F0705006” in line 710 (“<LinkID> . . . </LinkID>”) corresponding to line 410. Line 713 (“<FullLink> . . . </FullLink>”) specifies the complete name of the heading/section “plng@kb@TopOfPage” in the index file of the content portions identified by the link identifier “F0705006”. Line 717 (“<BookAcro> . . . </BookAcro>”) specifies the unique identifier “plng” of the document from which the display file has been formed (as specified in line 620).

Line 715 (“<LinkIDSourceFile> . . . </LinkIDSourceFile>”) specifies the location “Experion R300.0\PSp\plng.htm#TopOfPage” of the display file containing the content portion identified by the link identifier “F0705006”. It may be observed that line 715 may be derived from line 630 specifying the directory location “Experion R300.0\PSp” of the display files and the name of the display file “plng.htm” specified in line 640 corresponding to the unique identifier of the document “plng”. The heading/section name “TopOfPage” specifies that it is the beginning of the document as specified in line 515. It may be noted that the link identifier “F0705006” may have been specified instead of the heading/section name “TopOfPage” as they both correspond to the same line 515 in the display file depicted in FIG. 5.

It may be appreciated that for each link identifier “<LinkID>”, only the location “<LinkIDSourceFile>” of the display file is required for linking referring content portions to the referenced content portions as identified by the link identifier. As such, the link information may contain only the pairs of link identifiers and the locations of the display files corresponding to the link identifiers.

Lines 757 to 765 (“<USER> . . . </USER>”) specify a single display file with identifier “Experion R300.0\PSp\CF9UG-06.HTM” specified in line 763 (“<FilePath> . . . </FilePath>”) containing referencing content portions linking to referenced content portion identified by “F0705006” specified in line 760 (“<LinkID> . . . </LinkID>”). It should be noted that the information in lines 755-795 might be used for generating reports or for bookkeeping purposes.

In general, all the information of FIGS. 5-7 is generated from the referenced content. The referencing content portions may be encoded and processed as illustrated with an example below.

6. Referencing Content Portions

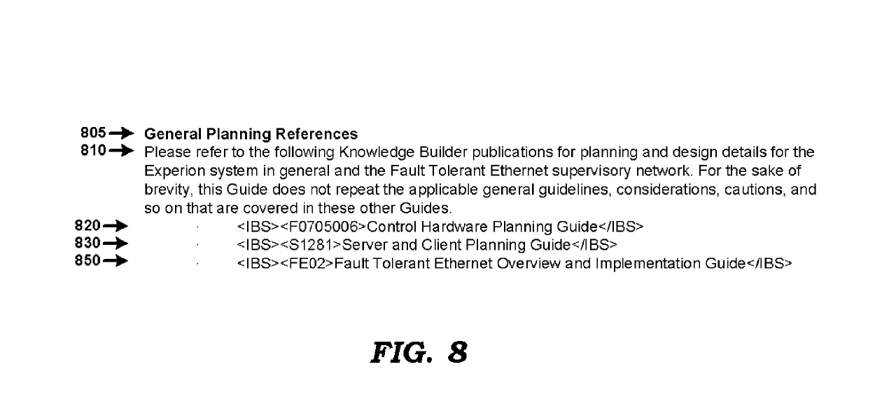

FIG. 8 depicts the content of a document containing link identifiers linking referring content portions to referenced content portions in other documents. Lines 805 and 810 contain content of the document. Line 820 specifies a link identifier “F0705006” and an associated portion of text “Control Hardware Planning Guide” using the tags “<IBS>” and “</IBS>”, thereby specifying a reference to the content portion (lines 410 to 480) identified by the link identifier “F0705006”. Similarly, lines 830 and 850 specify references to content portions identified by “S1281” and “FE02” respectively.

It should be appreciated that a developer would insert the lines 820, 830 and 850, again possibly using word processing software using which the referencing document of FIG. 8 or the referenced document of FIG. 4 was developed.

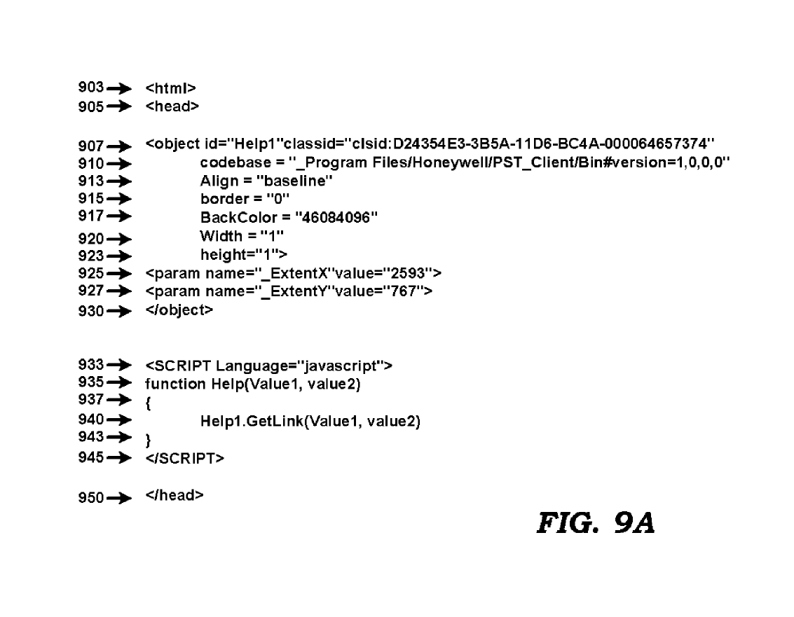

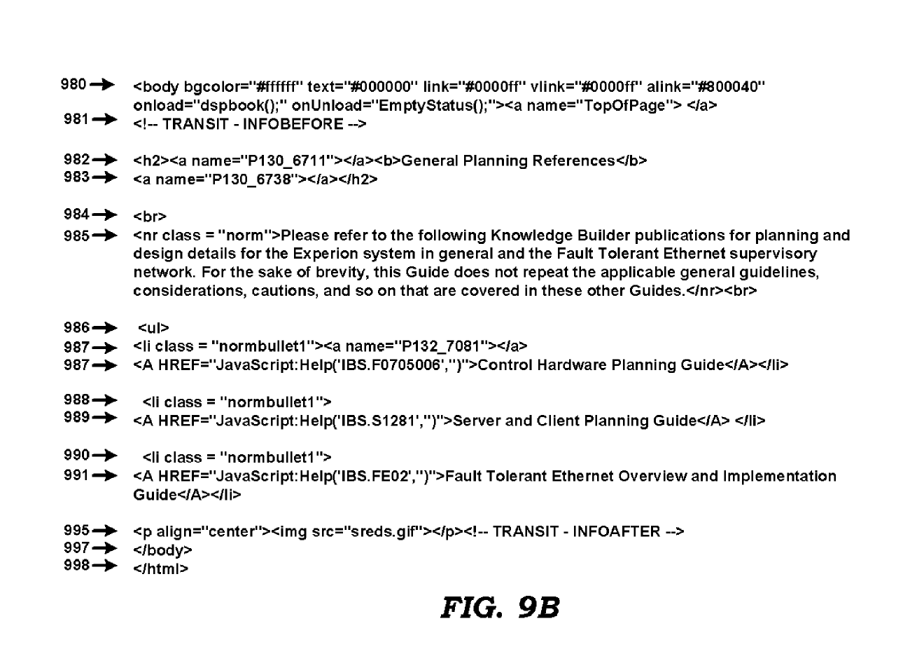

FIGS. 9A and 9B depict the content of a display file (encoded in HTML) formed from the content of a document containing referring content portions (depicted in FIG. 8). Lines 903 to 998 specify html tags that are formed corresponding to lines 805 to 850.

Lines 905 to 950 (<head> . . . </head>) forms part of a header that is added (by publishing system 150) to HTML tags generated corresponding to the content portion of FIG. 8. The header facilitates the linking of referenced portions using the corresponding link identifiers.

Lines 907 to 930 (<object> . . . </object>) specify the object with name/id “Help1” as specified in line 907 (using the attribute “id”) that is to be embedded in the HTML file and which is used to send the link identifier along with the request URL from end user system 140 to server system 130.

Lines 933 to 945 (<SCRIPT> . . . </SCRIPT>) specify a function (with name “Help” as specified in line 935) that is invoked in the HTML tags thereby enabling the link identifier to be passed as the parameter “value1” to the object embedded (“Help1”) using pre-defined function “GetLink” of the object as specified in line 940.

It may be noted that though not shown, the parameter “value2” may be used to pass the unique identifier of the document from which the display file containing the referenced content portion was formed. This may be required in a scenario where two link identifiers from two different documents are identical.

Line 987 (<a> . . . </a>) specifies html tags formed corresponding to line 820 and depicts the text “Control Hardware Planning Guide” associated with the link identifier and the call to the function “Help” with the link identifier “F0705006”. Lines 989 and 991 specify link identifiers and associated texts corresponding to lines 830 and 850 respectively.

The manner in which the HTML file depicted in FIGS. 9A and 9B is linked to the content portion (in the HTML file depicted in FIG. 5) identified by the link identifier “F0705006” is described in detail below.

7. Linking of Display Files

FIG. 10 is a flowchart illustrating the manner in which display files are linked, according to an aspect of the present invention. The flowchart is described with respect to FIG. 1 merely for illustration. The features can however be implemented in other environments as well, as will be apparent to one skilled in the relevant arts by reading the disclosure provided herein. The flowchart begins in step 1001, wherein control immediately passes to step 1020.

In step 1020, end user system 140 displays a display file containing link identifiers representing content portions that can be accessed by a user. In the examples described above, the display file of FIGS. 9A and 9B is displayed in a web browser. The link identifier “F0705006” specified in line 987 is rendered as a hyperlink along with the associated text “Control Hardware Planning Guide”. Similarly, the link identifiers and their associated text specified in lines 989 and 991 are also rendered as hyperlinks.

In step 1040, end user system 140 enables the user to specify a link identifier representing the content portion of interest. In the example described above, the user using the web browser can click on the hyperlink that specifies the content portion of interest. When the user click on the hyperlink for link identifier “F0705006” specified in line 987, the function “Help” with the link identifier “F0705006” is invoked, which then invokes the pre-defined function “GetLink” of the object “Help1” embedded in the HTML file as described in detail above. The embedded object sends a request URL containing the link identifier “F0705006” to server system 130.

In step 1060, server system 130 checks for the link identifier specified by the user (received from end user system 140) in a link information containing a list of link identifiers and the corresponding display files. In the embodiment described above, server system 130 receives the link identifier “F0705006” from end user system 140 and checks in the link information (depicted in FIG. 7). The link identifier “F0705006” is found in line 710 and the corresponding display file “Experion R300.0\PSp\plng.htm#TopOfPage” is sent as the response to end user system 140.

In step 1080, end user system 140 displays the display file (received from server system 130) corresponding to the link identifier specified by the user. The flow chart ends in step 1099. It should be appreciated that the features of the end user system and the server system may be implemented together as a single digital processing system.

It should further be appreciated that the features described above can be implemented in various embodiments as a desired combination of one or more of hardware, software and firmware. The description is continued with respect to an embodiment in which various features are operative when software instructions are executed.

8. Digital Processing System

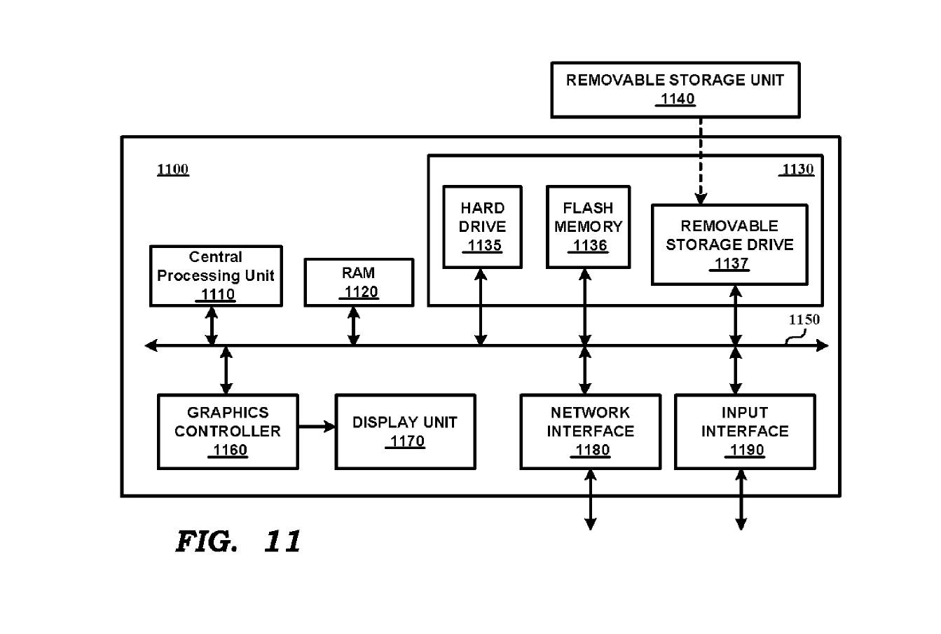

FIG. 11 is a block diagram illustrating the details of digital processing system 1100 in which various aspects of the present invention are operative by execution of appropriate software instructions. Digital processing system 1100 may correspond to any of publishing system 150, server system 130 and end user system 140. Digital processing system 1100 may contain one or more processors such as central processing unit (CPU) 1110, random access memory (RAM) 1120, secondary memory 1130, graphics controller 1160, display unit 1170, network interface 1180, and input interface 1190. All the components except display unit 1170 may communicate with each other over communication path 1150, which may contain several buses as is well known in the relevant arts. The components of FIG. 11 are described below in further detail.

CPU 1110 may execute instructions stored in RAM 1120 to provide several features of the present invention. CPU 1110 may contain multiple processing units, with each processing unit potentially being designed for a specific task. Alternatively, CPU 1110 may contain only a single general purpose, processing unit. RAM 1120 may receive instructions from secondary memory 1130 using communication path 1150.

Graphics controller 1160 generates display signals (e.g., in RGB format) to display unit 1170 based on data/instructions received from CPU 1110. Display unit 1170 contains a display screen to display the images defined by the display signals. Input interface 1190 may correspond to a key-board and/or mouse. Network interface 1180 provides connectivity to a network (e.g., using Internet Protocol), and may be used to communicate with the other systems of FIG. 1 (to send the display files and link/index information to server system 130).

Secondary memory 1130 may contain hard drive 1135, flash memory 1136, and removable storage drive 1137. Secondary memory 1130 may store the data and software instructions (to perform the steps of FIG. 2), which enable digital processing system 1100 to provide several features in accordance with the present invention. Some or all of the data and instructions may be provided on removable storage unit 1140, and the data and instructions may be read and provided by removable storage drive 1137 to CPU 1110. Floppy drive, magnetic tape drive, CD-ROM drive, DVD Drive, Flash memory, removable memory chip (PCMCIA Card, EPROM) are examples of such removable storage drive 1137.

Removable storage unit 1140 may be implemented using medium and storage format compatible with removable storage drive 1137 such that removable storage drive 1137 can read the data and instructions. Thus, removable storage unit 1140 includes a computer readable storage medium having stored therein computer software and/or data.

In this document, the term “computer program product” is used to generally refer to removable storage unit 1140 or hard disk installed in hard drive 1135. These computer program products are means for providing software to digital processing system 1100. CPU 1110 may retrieve the software instructions, and execute the instructions to provide various features of the present invention described above.

### 9. CONCLUSION

While various embodiments of the present invention have been described above, it should be understood that they have been presented by way of example only, and not limitation. Thus, the breadth and scope of the present invention should not be limited by any of the above described exemplary embodiments, but should be defined only in accordance with the following claims and their equivalents. Also, the various aspects, features, components and/or embodiments of the present invention described above may be embodied singly or in any combination in a data storage system such as a database system.

What is claimed is:

1. A method of facilitating access of related content portions developed independently, said method comprising:
receiving a first document containing a plurality of content portions and a plurality of link identifiers, wherein each of said plurality of link identifiers identifies a corresponding one of said plurality of content portions and wherein said plurality of content portions are accessible from other documents;
forming a set of display files containing said plurality of content portions;
generating a plurality of pairs, wherein each of said plurality of pairs contains a link identifier and a subset of display files, said subset of display files being contained in said set of display files, wherein each of said subset of display files contains a content portion identified by said link identifier;
displaying a second file to a user, said second file containing said link identifier associated with a portion of said second file;
enabling said user to select said portion of said second file;
examining said plurality of pairs to determine said subset of display files corresponding to said link identifier associated with said portion selected by said user; and
displaying said subset of display files.

2. The method of claim 1, wherein said second file is contained in a second set of display files formed from a second document.

3. The method of claim 2, wherein said link identifier is contained in said second document.

4. The method of claim 1, further comprising:
storing said set of display files in a non-volatile storage; and
retrieving said subset of display files corresponding to said link identifier from said non-volatile storage, wherein said subset of display files are displayed after said retrieving.

5. The method of claim 4, wherein said set of display files contains the corresponding content portions encoded in the form of hypertext markup language (HTML).

6. The method of claim 4, wherein said second file and said subset of display files are displayed in a user system, said method further comprising:
sending said link identifier associated with said portion selected by said user in said user system to a server system,
wherein said server system retrieves said subset of display files identified by said link identifier.

7. The method of claim 1, wherein said subset of display files comprises a single file.

8. The method of claim 1, further comprising:
storing said plurality of pairs in a non-volatile storage; and
retrieving said plurality of pairs from said non-volatile storage, wherein said examining examines the retrieved plurality of pairs.

9. The method of claim 8, wherein said plurality of pairs are stored encoded according to extended markup language (XML).

10. The method of claim 1, wherein each of said plurality of link identifiers contains an identifier of said first document.

11. A method of linking content portions developed independently, said method comprising:
receiving a first document containing a plurality of content portions accessible from other documents and a plurality of link identifiers, wherein each of said plurality of link identifiers identifies a corresponding one of said plurality of content portions;
forming a set of display files containing said plurality of content portions; and
generating a plurality of pairs, wherein each of said plurality of pairs contains a link identifier and a corresponding identified file, said identified file being contained in said set of display files, wherein said identified file contains a content portion identified by said link identifier,
wherein said link identifier can be encoded associated with a portion of a second document to link said content portion to said portion of said second document.

12. The method of claim 11, further comprising:
forming a second set of display files from said second document, wherein said link identifier is maintained associated with said portion contained in any of said second set of display files.

13. The method of claim 12, wherein said set of display files and said second set of display files are encoded in the form of hypertext markup language (HTML).

14. The method of claim 12, wherein said plurality of pairs is encoded according to extended markup language (XML).

15. A computer readable medium carrying one or more sequences of instructions for causing a system to facilitate access of related content portions developed independently, wherein execution of said one or more sequences of instructions by one or more processors contained in said system causes said one or more processors to perform the actions of:
receiving a first document containing a plurality of content portions and a plurality of link identifiers, wherein each of said plurality of link identifiers identifies a corresponding one of said plurality of content portions and wherein said plurality of content portions are accessible from other documents;
forming a set of display files containing said plurality of content portions;
generating a plurality of pairs, wherein each of said plurality of pairs contains a link identifier and a subset of display files, said subset of display files being contained in said set of display files, wherein each of said subset of display files contains a content portion identified by said link identifier;
displaying a second file to a user, said second file containing said link identifier associated with a portion of said second file;
enabling said user to select said portion of said second file;
examining said plurality of pairs to determine said subset of display files corresponding to said link identifier associated with said portion selected by said user; and
displaying said subset of display files.

16. The computer readable medium of claim 15, further comprising:
storing said set of display files in a non-volatile storage; and
retrieving said subset of display files corresponding to said link identifier from said non-volatile storage, wherein said subset of display files are displayed after said retrieving.

17. A computer readable medium carrying one or more sequences of instructions for causing a system to link content portions developed independently, wherein execution of said one or more sequences of instructions by one or more processors contained in said system causes said one or more processors to perform the actions of:
receiving a first document containing a plurality of content portions accessible from other documents and a plurality of link identifiers, wherein each of said plurality of link identifiers identifies a corresponding one of said plurality of content portions;
forming a set of display files containing said plurality of content portions; and
generating a plurality of pairs, wherein each of said plurality of pairs contains a link identifier and a corresponding identified file, said identified file being contained in said set of display files, wherein said identified file contains a content portion identified by said link identifier,
wherein said link identifier can be encoded associated with a portion of a second document to link said content portion to said portion of said second document.

18. A system facilitating access of related content portions developed independently, said system comprising:
means for receiving a first document containing a plurality of content portions and a plurality of link identifiers, wherein each of said plurality of link identifiers identifies a corresponding one of said plurality of content portions and wherein said plurality of content portions are accessible from other documents;
means for forming a set of display files containing said plurality of content portions;
means for generating a plurality of pairs, wherein each of said plurality of pairs contains a link identifier and a subset of display files, said subset of display files being contained in said set of display files, wherein each of said subset of display files contains a content portion identified by said link identifier;
means for displaying a second file to a user, said second file containing said link identifier associated with a portion of said second file;
means for enabling said user to select said portion of said second file;
means for examining said plurality of pairs to determine said subset of display files corresponding to said link identifier associated with said portion selected by said user; and
means for displaying said subset of display files.

19. The system of claim 18, further comprising:
means for storing said set of display files in a non-volatile storage; and
means for retrieving said subset of display files corresponding to said link identifier from said non-volatile storage, wherein said subset of display files are displayed after said retrieving.

20. A system for linking content portions developed independently, said system comprising:
means for receiving a first document containing a plurality of content portions accessible from other documents and a plurality of link identifiers, wherein each of said plurality of link identifiers identifies a corresponding one of said plurality of content portions;
means for forming a set of display files containing said plurality of content portions; and
means for generating a plurality of pairs, wherein each of said plurality of pairs contains a link identifier and a corresponding identified file, said identified file being contained in said set of display files, wherein said identified file contains a content portion identified by said link identifier,
wherein said link identifier can be encoded associated with a portion of a second document to link said content portion to said portion of said second document.
